(19) United States
(12) Patent Application Publication
(10) Pub. No.: US 2014/0051362 A1
(43) Pub. Date: Feb. 20, 2014

(54) BLUETOOTH DEVICE CONNECTION METHOD AND BLUETOOTH DEVICE

(71) Applicant: Huawei Device Co., Ltd., Shenzhen (CN)

(72) Inventor: Ji Ding, Shanghai (CN)

(73) Assignee: Huawei Device Co., Ltd., Shenzhen (CN)

(21) Appl. No.: 14/061,996

(22) Filed: Oct. 24, 2013

Related U.S. Application Data
(63) Continuation of application No. PCT/CN2011/073325, filed on Apr. 26, 2011.

(51) Int. Cl. H04B 7/26

(52) U.S. Cl. CPC H04B 7/26
USPC 455/41.2

(57) ABSTRACT

Embodiments of the present invention provide a bluetooth device connection method and a bluetooth device. The method includes: determining a device class of a to-be-connected bluetooth device, where the device class includes an audio device class and a non-audio device class; and if it is determined that the device class of the to-be-connected bluetooth device is the audio device class, using a preset connection identifier corresponding to the to-be-connected bluetooth device to establish a data connection with the to-be-connected bluetooth device. In the embodiments of the present invention, there is no need to obtain a connection identifier corresponding to the to-be-connected bluetooth device of the audio device class, thereby shortening time for establishing a data connection, and improving efficiency for establishing a data connection.

### CROSS-REFERENCE TO RELATED APPLICATIONS

This application is a continuation of International Application No. PCT/CN2011/073325, filed on Apr. 26, 2011, which is hereby incorporated by reference in its entirety.

### TECHNICAL FIELD

Embodiments of the present invention relate to communications technologies, and in particular, to a bluetooth device connection method and a bluetooth device.

### BACKGROUND

Bluetooth (Bluetooth) is a radio technology supporting short-distance communication (usually within 10 m) between devices, works at a globally available 2.4 GHz radio wave band, and is capable of transmitting data between devices such as a mobile phone, a personal digital assistant (Personal Digital Assistant, PDA for short), a notebook computer, a wireless headphone, an on-board tool, an adapter, and a printer. In embodiments of the present invention, a terminal device with a bluetooth function may be called a bluetooth device. Before two bluetooth devices transmit data, a pairing connection must be performed, and during pairing, both must use a same connection identifier (for example: a pairing code) to establish a data connection between the two. When two bluetooth devices establish a data connection for the first time, a connection identifier input by a user may be used to establish the data connection between the two bluetooth devices; and the connection identifier is stored. When the two bluetooth devices establish a data connection for the second time, the user does not need to input the connection identifier again, that is, the stored connection identifier may be used to establish the data connection between the two bluetooth devices.

However, because storage space of a bluetooth device is limited, it may be caused that a connection identifier corresponding to a to-be-connected bluetooth device cannot be stored. Therefore, when two bluetooth devices establish a data connection, a connection identifier input by a user needs to be obtained each time, thereby prolonging time for establishing a data connection, and decreasing efficiency for establishing a data connection.

### SUMMARY

Embodiments of the present invention provide a bluetooth device connection method and a bluetooth device, which are used to shorten time for establishing a data connection, and improve efficiency for establishing a data connection.

An embodiment of the present invention provides a bluetooth device connection method, including:

determining a device class of a to-be-connected bluetooth device, where the device class includes an audio device class and a non-audio device class; and

if it is determined that the device class of the to-be-connected bluetooth device is the audio device class, using a preset connection identifier corresponding to the to-be-connected bluetooth device to establish a data connection with the to-be-connected bluetooth device.

An embodiment of the present invention further provides a bluetooth device, including:

a determining unit, configured to determine a device class of a to-be-connected bluetooth device, where the device class includes an audio device class and a non-audio device class; and

a connecting unit, configured to, if the determining unit determines that the device class of the to-be-connected bluetooth device is the audio device class, use a preset connection identifier corresponding to the to-be-connected bluetooth device to establish a data connection with the to-be-connected bluetooth device.

It may be known from the foregoing technical solutions that, in the embodiments of the present invention, a device class of a to-be-connected bluetooth device is determined, and if it is determined that the device class of the to-be-connected bluetooth device is an audio device class, a preset connection identifier corresponding to the to-be-connected bluetooth device may be used to establish a data connection with the to-be-connected bluetooth device, and there is no need to obtain a connection identifier corresponding to the to-be-connected bluetooth device of the audio device class (for example: obtain a connection identifier input by a user or obtain a stored connection identifier), thereby shortening time for establishing a data connection, and improving efficiency for establishing a data connection.

### BRIEF DESCRIPTION OF DRAWINGS

To illustrate the technical solutions in the embodiments of the present invention more clearly, the following briefly introduces accompanying drawings required for describing the embodiments. Apparently, the accompanying drawings in the following description show merely some embodiments of the present invention, and persons of ordinary skill in the art may still derive other drawings according to these accompanying drawings without creative efforts.

FIG. 1 is a schematic flowchart of a bluetooth device connection method according to a first embodiment of the present invention;

FIG. 2 is a schematic structural diagram of a bluetooth device according to a second embodiment of the present invention;

FIG. 3 is another schematic structural diagram of a bluetooth device according to the second embodiment of the present invention; and

FIG. 4 is another schematic structural diagram of a bluetooth device according to the second embodiment of the present invention.

### DESCRIPTION OF EMBODIMENTS

To make the objectives, the technical solutions, and the advantages of the embodiments of the present invention clearer, the following clearly describes the technical solutions in the embodiments of the present invention with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

It should be noted that, a bluetooth device involved in the embodiments of the present invention includes, but is not limited to, a mobile phone, a PDA, a notebook computer, an MP3 player, an MP4 player, a wireless headphone, an on-board tool, an adapter, and a printer.

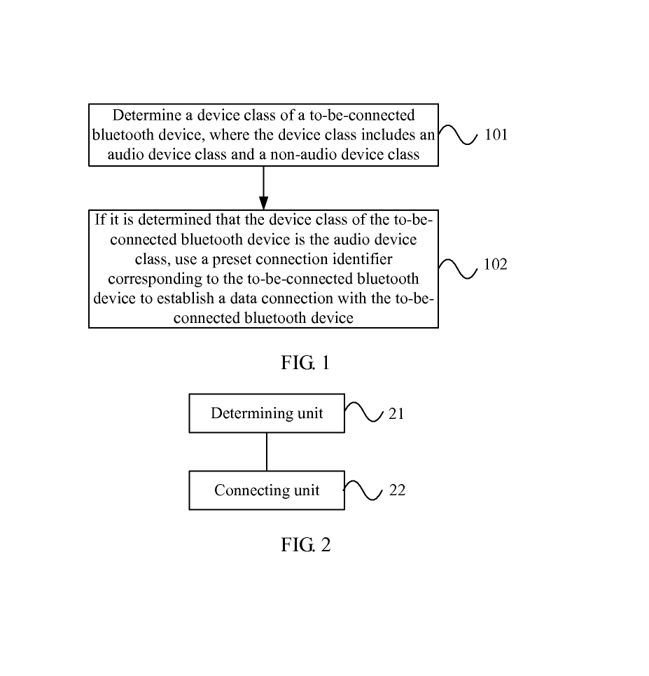

FIG. 1 is a schematic flowchart of a bluetooth device connection method according to a first embodiment of the present invention. As shown in FIG. 1, the bluetooth device connection method in this embodiment including:

Step 101: Determine a device class of a to-be-connected bluetooth device, where the device class includes an audio device class and a non-audio device class.

Specifically, the device class of the to-be-connected bluetooth device may be determined according to attribute information of the to-be-connected bluetooth device, namely, a bluetooth major device class (Bluetooth Major Device Class). For example, when a value of a bluetooth major device class field is 0x0400, it indicates that the device class of the to-be-connected bluetooth device is the audio device class; when the value of the bluetooth major device class field is not 0x0400, it indicates that the device class of the to-be-connected bluetooth device is the non-audio device class.

Step 102: If it is determined that the device class of the to-be-connected bluetooth device is the audio device class, use a preset connection identifier corresponding to the to-be-connected bluetooth device to establish a data connection with the to-be-connected bluetooth device.

Due to lack of an input interface and an input apparatus, a bluetooth device of an audio device class, for example: a wireless headphone (a wireless headphone with a bluetooth function), and an on-board tool (an on-board tool with a bluetooth function), is generally pre-configured with a specific connection identifier (for example: 0000, and 1234) as a default pairing code before delivery. In this step, specifically, a bluetooth identifier (that is, a specific connection identifier pre-configured before delivery) in the to-be-connected bluetooth device for establishing a data connection may be preset to the connection identifier. Because the device class of the to-be-connected bluetooth device in this case is the audio device class, the preset connection identifier corresponding to the to-be-connected bluetooth device is a connection identifier of an audio device. In this embodiment, an executive body may provide a bluetooth device of an audio device class with a user setting item (which may also be omitted, and when the user setting item is omitted, a default pairing code “0000” is used) of a connection identifier (pairing code), and allow a user to input a specific connection identifier as a default pairing code, for example: 0000, and 1234.

Further, if it is determined that the device class of the to-be-connected bluetooth device is the non-audio device class, use a connection identifier corresponding to the to-be-connected bluetooth device to establish a data connection with the to-be-connected bluetooth device. Further, before this step, a step of obtaining a connection identifier corresponding to the to-be-connected bluetooth device may be further included. Specifically, a connection identifier which corresponds to the to-be-connected bluetooth device and is provided by a user may be obtained, or a stored connection identifier corresponding to the to-be-connected bluetooth device may also be obtained.

In this embodiment, a device class of a to-be-connected bluetooth device is determined, and if it is determined that the device class of the to-be-connected bluetooth device is an audio device class, a preset connection identifier corresponding to the to-be-connected bluetooth device may be used to establish a data connection with the to-be-connected bluetooth device, and there is no need to obtain a connection identifier corresponding to the to-be-connected bluetooth device of the audio device class (for example: obtain a connection identifier input by a user or obtain a stored connection identifier), thereby shortening time for establishing a data connection, and improving efficiency for establishing a data connection.

It should be noted that, for brevity of description, the foregoing method embodiment is described as a series of action combinations. However, persons skilled in the art should understand that the present invention is not limited to order of the described actions, because according to the present invention, some steps may adopt other order or may be performed simultaneously. Moreover, persons skilled in the art should be aware that the described embodiment in the specification belongs to an exemplary embodiment, and the involved actions and units are not necessarily required by the present invention.

In the foregoing embodiments, description of each embodiment has its emphasis. For a part that is not described in detail in a certain embodiment, reference may be made to related description in another embodiment.

FIG. 2 is a schematic structural diagram of a bluetooth device according to a second embodiment of the present invention. As shown in FIG. 2, the bluetooth device in this embodiment may include a determining unit 21 and a connecting unit 22. The determining unit 21 is configured to determine a device class of a to-be-connected bluetooth device, where the device class includes an audio device class and a non-audio device class; and the connecting unit 22 is configured to, if the determining unit 21 determines that the device class of the to-be-connected bluetooth device is the audio device class, use a preset connection identifier corresponding to the to-be-connected bluetooth device to establish a data connection with the to-be-connected bluetooth device.

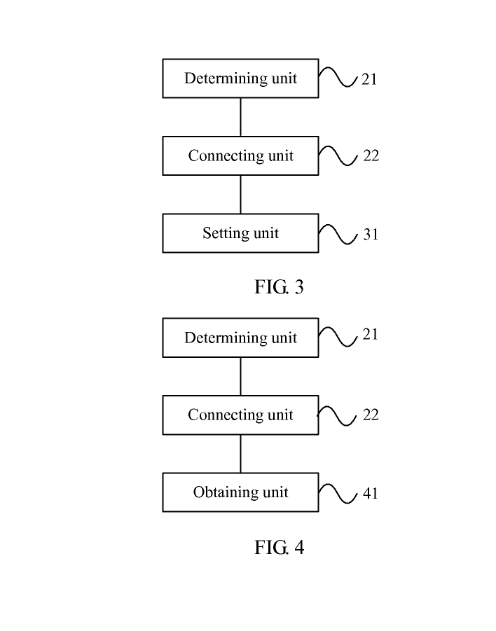

Further, as shown in FIG. 3, the bluetooth device provided in this embodiment may include a setting unit 31, configured to preset a bluetooth identifier in the to-be-connected bluetooth device for establishing a data connection to the connection identifier.

Further, the connecting unit 22 in this embodiment may be configured to, if the determining unit 21 determines that the device class of the to-be-connected bluetooth device is the non-audio device class, use a connection identifier corresponding to the to-be-connected bluetooth device to establish a data connection with the to-be-connected bluetooth device. Accordingly, as shown in FIG. 4, the bluetooth device in this embodiment may further include an obtaining unit 41, configured to obtain the connection identifier corresponding to the to-be-connected bluetooth device, so that the connecting unit 22 establishes the data connection with the to-be-connected bluetooth device. Optionally, the obtaining unit 41 may specifically obtain a connection identifier which corresponds to the to-be-connected bluetooth device and is provided by a user, or may also obtain a stored connection identifier corresponding to the to-be-connected bluetooth device.

In this embodiment, a device class of a to-be-connected bluetooth device is determined by a determining unit, and if the determining unit determines that the device class of the to-be-connected bluetooth device is an audio device class, a connecting unit may use a preset connection identifier corresponding to the to-be-connected bluetooth device to establish a data connection with the to-be-connected bluetooth device, and there is no need to obtain a connection identifier corresponding to the to-be-connected bluetooth device of the audio device class (for example: obtain a connection identifier input by a user or obtain a stored connection identifier), thereby shortening time for establishing a data connection, and improving efficiency of establishing a data connection.

Persons of ordinary skill in the art may understand that, all or part of the steps of the foregoing method embodiment may be implemented by a program instructing relevant hardware. The program may be stored in a computer readable storage medium. When the program is run, the steps included in the foregoing method embodiment are performed. The storage medium may be any medium capable of storing program codes, such as a ROM, a RAM, a magnetic disk, or an optical disk

Finally, it should be noted that the foregoing embodiments are merely intended for describing the technical solutions of the present invention rather than limiting the present invention. Although the present invention is described in detail with reference to the foregoing embodiments, persons of ordinary skill in the art should understand that they may still make modifications to the technical solutions recorded in the foregoing embodiments or make equivalent replacements to part of technical features of the technical solutions recorded in the foregoing embodiments; however, these modifications or replacements do not make the essence of the corresponding technical solutions depart from the spirit and scope of the technical solutions of the embodiments of the present invention.

What is claimed is:

1. A bluetooth device connection method, comprising:
determining a device class of a to-be-connected bluetooth device, wherein the device class comprises an audio device class and a non-audio device class; and
if it is determined that the device class of the to-be-connected bluetooth device is the audio device class, using a preset connection identifier corresponding to the to-be-connected bluetooth device to establish a data connection with the to-be-connected bluetooth device.

2. The method according to claim 1, further comprising:
presetting a bluetooth identifier in the to-be-connected bluetooth device for establishing a data connection to the connection identifier.

3. The method according to claim 1, further comprising:
if it is determined that the device class of the to-be-connected bluetooth device is the non-audio device class, using a connection identifier corresponding to the to-be-connected bluetooth device to establish a data connection with the to-be-connected bluetooth device.

4. The method according to claim 2, further comprising:
if it is determined that the device class of the to-be-connected bluetooth device is the non-audio device class, using a connection identifier corresponding to the to-be-connected bluetooth device to establish a data connection with the to-be-connected bluetooth device.

5. The method according to claim 3, wherein before the using a connection identifier corresponding to the to-be-connected bluetooth device to establish a data connection with the to-be-connected bluetooth device, the method further comprises:
obtaining a connection identifier corresponding to the to-be-connected bluetooth device.

6. The method according to claim 5, wherein the obtaining a connection identifier corresponding to the to-be-connected bluetooth device comprises:
obtaining a connection identifier which corresponds to the to-be-connected bluetooth device and is provided by a user; or
obtaining a stored connection identifier corresponding to the to-be-connected bluetooth device.

7. A bluetooth device, comprising:
a determining unit, configured to determine a device class of a to-be-connected bluetooth device, wherein the device class comprises an audio device class and a non-audio device class; and
a connecting unit, configured to, if the determining unit determines that the device class of the to-be-connected bluetooth device is the audio device class, use a preset connection identifier corresponding to the to-be-connected bluetooth device to establish a data connection with the to-be-connected bluetooth device.

8. The bluetooth device according to claim 7, further comprising:
a setting unit, configured to set a bluetooth identifier in the to-be-connected bluetooth device for establishing a data connection to the connection identifier.

9. The bluetooth device according to claim 7, wherein the connecting unit is further configured to:
if the determining unit determines that the device class of the to-be-connected bluetooth device is the non-audio device class, use a connection identifier corresponding to the to-be-connected bluetooth device to establish a data connection with the to-be-connected bluetooth device.

10. The bluetooth device according to claim 8, wherein the connecting unit is further configured to:
if the determining unit determines that the device class of the to-be-connected bluetooth device is the non-audio device class, use a connection identifier corresponding to the to-be-connected bluetooth device to establish a data connection with the to-be-connected bluetooth device.

11. The bluetooth device according to claim 9, further comprising:
an obtaining unit, configured to obtain the connection identifier corresponding to the to-be-connected bluetooth device, so that the connecting unit establishes the data connection with the to-be-connected bluetooth device.

12. The bluetooth device according to claim 11, wherein the obtaining unit is configured to obtain a connection identifier which corresponds to the to-be-connected bluetooth device and is provided by a user; or
obtain a stored connection identifier corresponding to the to-be-connected bluetooth device.
